(19) United States
(12) Patent Application Publication
(10) Pub. No.: US 2011/0267453 A1
(43) Pub. Date: Nov. 3, 2011

(54) SURFACE INSPECTING APPARATUS AND METHOD

(75) Inventor: Junichi MATSUMOTO, Tochigi (JP)

(73) Assignee: HONDA MOTOR CO., LTD., Tokyo (JP)

(21) Appl. No.: 13/094,424

(22) Filed: Apr. 26, 2011

(30) Foreign Application Priority Data
Apr. 30, 2010 (JP) 2010-104683

(51) Int. Cl. H04N 7/18

(52) U.S. Cl. 348/128; 348/E07.085

(57) ABSTRACT

A surface is inspected by irradiating a light in a specific waveband onto a surface coated film which is formed on a surface of a workpiece and absorbs said specific waveband, picking up an image of a reflected light of the light irradiated onto the workpiece by an image pickup portion having a sensitivity to a light in said specific waveband, and inspecting a condition of the surface coated film based on the picked-up image.

### BACKGROUND OF THE INVENTION

### 1. Field of the Invention

The present invention relates to a surface inspecting apparatus and method which picks up an image of a surface of a workpiece, thereby inspecting a condition of the surface of the workpiece.

2. Related Art

JP-A-2001-314817 discloses a conventional system for inspecting a surface of a workpiece. In the system, a stripe light source including a lamp and a grid provided with a plurality of linear slits irradiates a light on the workpiece to form a stripe-shaped shadow on the surface of the workpiece. Then, a CCD camera picks up an image of the stripe-shaped shadow on the surface of the workpiece so that the image thus picked up is displayed on a monitor. An operator checks a bending of the stripe-shaped shadow on the monitor, and inspects a condition of the surface of the workpiece.

However, according to the above conventional system, in the case that the workpiece is coated with a luster pigment, the irradiated light might be irregularly reflected by the luster pigment so that an accuracy of a result of the inspection would be greatly damaged.

As shown in FIG. 7, a workpiece 100 to be inspected has a structure that an undercoated film 104 subjected to electrodeposition coating and an intercoated film 106 are provided on a basis 102, for example, a steel plate. An overcoated base film 108 and an overcoated clear film 110 are formed on the intercoated film 106. The overcoated base film 108 is formed by a coating material containing a luster pigment, for example, using aluminum or mica.

An irradiating portion 112 irradiates, on the workpiece 100, a visible light having a plurality of stripe-shaped shadows. The irradiating portion 112 includes a light source 114 for emitting a light, a diffuser panel 116 for diffusing the light from the light source 114, and a projection chart 118. The projection chart 118 has, for example, a grid provided with a plurality of linear stripes. The light emitted from the light source 114 passes through the diffuser panel 116 and the projection chart 118 so that the light having the stripe-shaped shadows is irradiated on the workpiece 100.

A camera 120 has a polarizing filter 122, a lens 124 and a CCD 126. The camera 120 picks up an image of a light reflected by the workpiece 100. The camera 120 picks up an image of a shadow (a plurality of stripe-shaped shadows) of the projection chart 118 which is projected onto the workpiece 100 through the irradiation carried out by the irradiating portion 112. The image thus obtained is displayed on a monitor (not shown). In the case that the stripe-shaped shadow thus displayed is remarkably bent locally, an operator determines that dusts or the like would exist on the surface of the workpiece 100. The polarizing filter 122 serves to transmit a light having a P wave therethrough. The CCD 126 receives, through the lens 124, the light having the P wave which is transmitted through the polarizing filter 122.

At this time, a bent light which is incident on the overcoated clear film 110 and is thus refracted is irregularly reflected on the overcoated base film 108. Then, an image of the light thus reflected irregularly (an irregularly reflected light) is also picked up by the camera 120. For this reason, a projection chart taken onto the image picked up is distorted (a stripe-shaped shadow is bent) or a halation is caused by the light reflected irregularly through the overcoated base film 108. Therefore, it is impossible to accurately inspect a condition of the surface of the workpiece.

As another surface inspecting method, moreover, the projection chart 118 is not used but the light emitted from the light source 114 is irradiated on the workpiece 100 and an image of a reflected light is picked up to inspect a place having refuse. In this case, an image processing such as a binarization is carried out over the picked-up image data and an image subjected to the image processing is displayed. In the case in which the displayed image has a black place, an operator determines that dusts or the like would exist.

As shown in FIG. 8, in the case in which a workpiece 100 has a structure in which an undercoated film 104 subjected to electrodeposition coating, an intercoated film 106, an overcoated base film 108 and an overcoated clear film 110 are formed on a basis 102 such as a steel plate, and furthermore, a decorating seal 130 having a character or logo printed thereon and a transparent or translucent overcoated clear film 132 are formed, a light which is incident on a surface of the workpiece 100 and is thus refracted is reflected by the decorating seal 130 due to an execution of a surface inspection so that an image of the character or logo printed on the decorating seal 130 is picked up by the camera 120. For this reason, the character or logo printed on the decorating seal 130 is displayed in a black or white color through a binarization. Therefore, it is impossible to accurately inspect a condition of the surface of the workpiece.

### SUMMARY OF THE INVENTION

One or more embodiments of the invention provide a surface inspecting apparatus and method for enhancing precision in an inspection of a surface coated film of a workpiece without an influence of a layer provided under the surface coated film.

In accordance with embodiments of the invention, a surface inspecting apparatus is provided with: an irradiating portion configured to irradiate a light in a specific waveband onto a surface coated film which is formed on a surface of a workpiece and absorbs a light in said specific waveband; an image pickup portion having a sensitivity to a light in said specific waveband and configured to pick up an image of a reflected light of the light irradiated onto the workpiece by the irradiating portion; an inspecting portion configured to inspect a condition of the surface coated film based on the image picked up by the image pickup portion; and a scanning portion configured to relatively move the surface of the workpiece with respect to the image pickup portion.

Moreover, in accordance with embodiments of the invention, a surface inspecting method includes the steps of: irradiating a light in a specific waveband onto a surface coated film which is formed on a surface of a workpiece and absorbs said specific waveband; picking up an image of a reflected light of the light irradiated onto the workpiece by an image pickup portion having a sensitivity to a light in said specific waveband; and inspecting a condition of the surface coated film based on the image picked up.

Other aspects and advantages of the invention will be apparent from the following description and the appended claims.

### BRIEF DESCRIPTION OF THE DRAWINGS

FIG. 1 is a block diagram showing a structure of a surface inspecting apparatus according to an exemplary embodiment,

FIG. 2 is a view showing an example of a principle for enhancing precision in an inspection of a surface of a workpiece through the surface inspecting apparatus according to the embodiment,

FIG. 3 is a view showing an example of an image picked up from a reflected light of an ultraviolet light irradiated by an irradiating portion through an image pickup portion illustrated in FIG. 2 in the case in which the surface of the workpiece has no concavo-convex portion,

FIG. 4 is a view showing an example of the image picked up from the reflected light of the ultraviolet light irradiated by the irradiating portion through the image pickup portion illustrated in FIG. 2 in the case in which the surface of the workpiece has the concavo-convex portion,

FIG. 5 is a view showing another example of the principle for enhancing precision in an inspection of a surface of a workpiece through the surface inspecting apparatus according to the embodiment,

FIG. 6 is a view showing an example of an image which is picked up from a reflected light of an ultraviolet light irradiated by an irradiating portion through an image pickup portion illustrated in FIG. 5 and is subjected to a binarization through an image processing apparatus in the case in which the surface of the workpiece has a concavo-convex portion,

FIG. 7 is a view showing a first problem of the related art, and

FIG. 8 is a view showing a second problem of the related art.

### DETAILED DESCRIPTION OF EXEMPLARY EMBODIMENT

A surface inspecting apparatus and method of an exemplary embodiment of the invention will be described below in detail with reference to accompanying drawings.

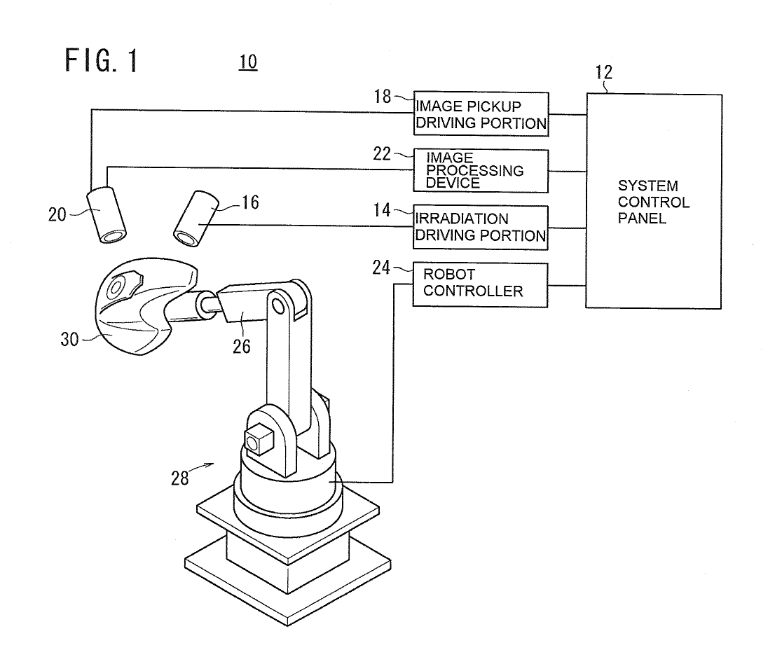

FIG. 1 is a block diagram showing a structure of a surface inspecting apparatus 10 according to the exemplary embodiment. The surface inspecting apparatus 10 includes a system control panel 12, an irradiation driving portion 14, an irradiating portion 16, an image pickup driving portion 18, an image pickup portion 20, an image processing device 22, a robot controller 24, and a robot 28 having a multispindle articulated arm 26.

The system control panel 12 serves to control the whole surface inspecting apparatus 10. The irradiation driving portion 14 drives the irradiating portion 16 in accordance with a control of the system control panel 12. Consequently, the irradiating portion 16 irradiates an ultraviolet light on a workpiece 30 such as a fuel tank of a motorcycle. A waveband or a wavelength of the ultraviolet light irradiated by the irradiating portion 16 is a waveband that can be absorbed by a surface coated film formed on a surface of the workpiece 30. In other words, the surface coated film contains a material capable of absorbing ultraviolet rays. The surface coated film may contain a benzotriazole based ultraviolet absorber or a benzophenone based ultraviolet absorber, for example. It is sufficient that a human body is relatively uninfluenced by the waveband of the ultraviolet light irradiated by the irradiating portion 16. More specifically, it is preferable that the waveband should be in a range of a waveband of near ultraviolet rays to UV-A or a range of UV-A, particularly, a range of 330 to 380 nanometers.

The image pickup driving portion 18 drives the image pickup portion 20 in accordance with the control of the system control panel 12 and causes the image pickup portion 20 to pick up an image of a reflected light of the ultraviolet light irradiated on the workpiece 30 by the irradiating portion 16. The image processing device 22 processes the image picked up by the image pickup portion 20. The image processing device 22 has a function (an inspecting portion) for inspecting a condition of the surface of the workpiece 30 by using the image picked up through the image pickup portion 20.

The robot controller 24 drives the arm 26 of the robot 28 (a scanning portion) in accordance with the control of the system control panel 12. Consequently, the arm 26 holds and moves the workpiece 30. The arm 26 moves the surface to be an inspecting target in the workpiece 30 relatively with the image pickup portion 20 so that the image pickup portion 20 can scan the surface to be the inspecting target.

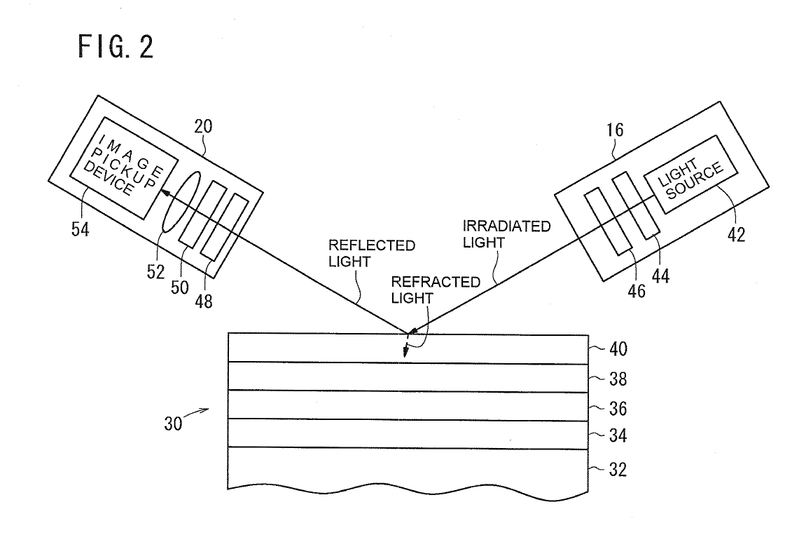

FIG. 2 is a view showing an example of a principle for enhancing precision in the inspection of the surface of the workpiece 30 by the surface inspecting apparatus 10 according to the embodiment. The workpiece 30 shown in FIG. 2 has a structure in which an undercoated film 34, an intercoated film 36, an overcoated base film (a lower coated film) 38, and an overcoated clear film (the surface coated film) 40 containing a material capable of absorbing an ultraviolet light are formed on a basis 32 such as a steel plate. In other words, the overcoated clear film is formed on the surface of the workpiece 30. The overcoated clear film 40 may be formed by a transparent or translucent material.

The irradiating portion 16 shown in FIG. 2 has a light source 42 for emitting an ultraviolet light, a diffuser panel 44 for diffusing the ultraviolet light emitted from the light source 42, and a projection chart 46. It is sufficient that the projection chart 46 takes a predetermined shape and serves to shield a part of the light diffused by the diffuser panel 44, thereby casting a shadow onto the workpiece 30. In the embodiment, the projection chart 46 has a grid provided with a plurality of linear stripes. Consequently, an ultraviolet light having a plurality of stripe-shaped shadows is projected onto the workpiece 30.

The image pickup portion 20 shown in FIG. 2 has a cut filter 48 for cutting a light other than lights in the ultraviolet band, a polarizing filter 50 for transmitting a P wave therethrough, a lens 52, and an image pickup device 54 such as a CCD or a CMOS which receives a light transmitted through the cut filter 48, the polarizing filter 50 and the lens 52. The image pickup device 54 has a sensitivity to at least a waveband of the ultraviolet light irradiated by the irradiating portion 16.

As shown in FIG. 2, when an ultraviolet light is irradiated on the workpiece 30 from the irradiating portion 16, a light bent by the overcoated clear film 40 in the irradiated ultraviolet light is absorbed into the overcoated clear film 40 so that an irregularly reflected light caused by the overcoated base film 38 is prevented from being emitted from the workpiece 30. Accordingly, the image pickup portion 20 can pick up an image of only a light reflected by the overcoated clear film 40.

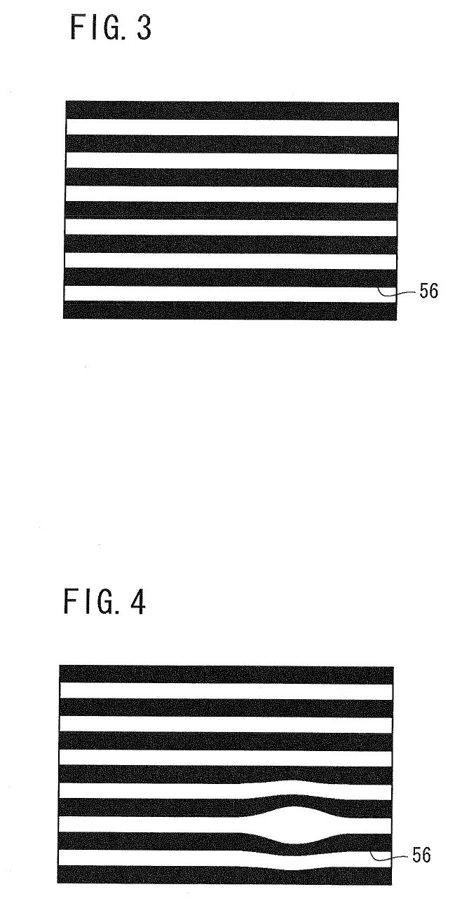

FIG. 3 is a view showing an example of an image picked up from the reflected light of the ultraviolet light irradiated by the irradiating portion 16 through the image pickup portion 20 illustrated in FIG. 2 in the case in which the surface of the workpiece 30, that is, the overcoated clear film 40 has no concavo-convex portion. FIG. 4 is a view showing an example of an image picked up from the reflected light of the ultraviolet light irradiated by the irradiating portion 16 through the image pickup portion 20 illustrated in FIG. 2 in the case in which the surface of the workpiece 30, that is, the overcoated clear film 40 has the concavo-convex portion.

As shown in FIGS. 3 and 4, a plurality of slit-shaped shadows 56 is generated on the surface of the workpiece 30 through the projection chart 46. In the case in which the surface of the overcoated clear film 40 has no concavo-convex portion, the slit-shaped shadows 56 are straight lines (see FIG. 3).

In the case in which the surface of the overcoated clear film 40 has the concavo-convex portion, however, the slit-shaped shadow 56 is bent as shown in FIG. 4. The concavo-convex portion is generated on the surface of the overcoated clear film 40 for the following reasons. When a contraction is not uniformly caused in a dryness of the coated film, a gentle concavo-convex portion is generated. In addition, in a stage in which the undercoated film 34, the intercoated film 36, the overcoated base film 38 and the overcoated clear film 40 are formed on the basis 32, dust or refuse mixes so that the concavo-convex portion is generated remarkably locally in only a place into which the dust or refuse mixes. For example, when the dust mixes after the undercoated film 34 is formed, the intercoated film 36, the overcoated base film 38 and the overcoated clear film 40 are formed thereon. Therefore, the concavo-convex portion is generated remarkably locally in only the place into which the dust mixes.

The image processing device 22 analyzes the image picked up by the image pickup portion 20 and inspects a place in which the concavo-convex portion is generated over the overcoated clear film 40. In other words, the image processing device 22 analyzes whether a plurality of slot-shaped cast shadows is straight or bent, and inspects the place in which the concavo-convex portion is generated over the overcoated clear film 40.

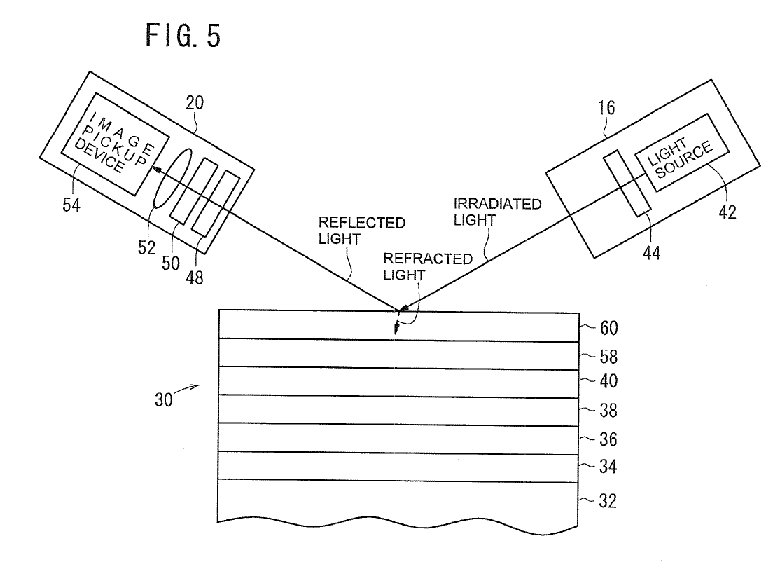

FIG. 5 is a view showing another example of the principle for enhancing precision in an inspection of the surface of the workpiece 30 through the surface inspecting apparatus 10 according to the embodiment. A workpiece 30 shown in FIG. 5 has a structure in which an undercoated film 34, an intercoated film 36, an overcoated base film 38 and an overcoated clear film 40 are formed on a basis 32 such as a steel plate, and furthermore, a decorating seal 58 having a character or logo printed thereon and an overcoated clear film 60 containing a material capable of absorbing an ultraviolet light are formed thereon. The same structures as those shown in FIG. 2 have the same reference numerals.

In case of the workpiece 30 shown in FIG. 5, the overcoated clear film 60 serves as the surface coated film. The overcoated clear film 60 is constituted by a transparent or translucent material, and the character or logo printed on the decorating seal 58 can be recognized visually from an outside. An irradiating portion 16 shown in FIG. 5 has a light source 42 and a diffuser panel 44 and does not have a projection chart 46. Since an image pickup portion 20 shown in FIG. 5 has the same structure as that of the image pickup portion 20 shown in FIG. 2, description will be omitted.

As shown in FIG. 5, when an ultraviolet light is irradiated on the workpiece 30 from the irradiating portion 16, a light bent by the overcoated clear film 60 in the irradiated ultraviolet light is absorbed into the overcoated clear film 60 so that a reflected light caused by the decorating seal 58 is prevented from being emitted from the workpiece 30. Accordingly, the image pickup portion 20 can pick up an image of only a light reflected by the overcoated clear film 60.

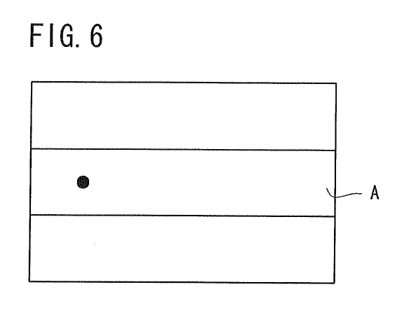

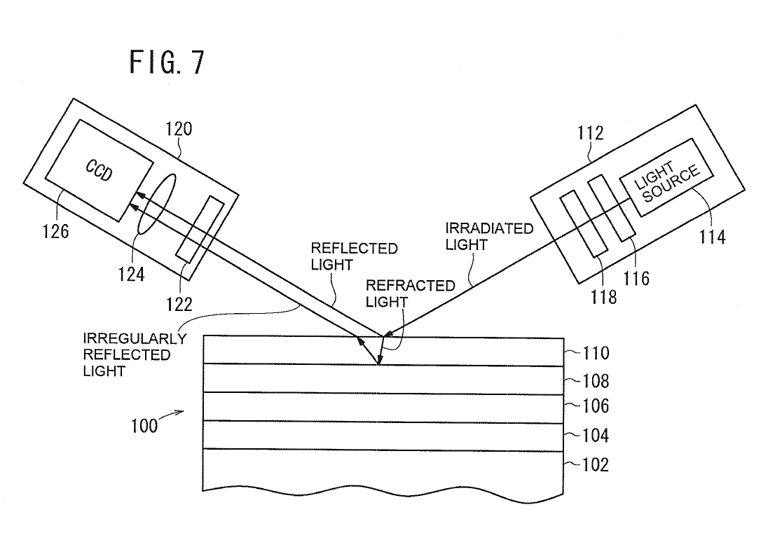

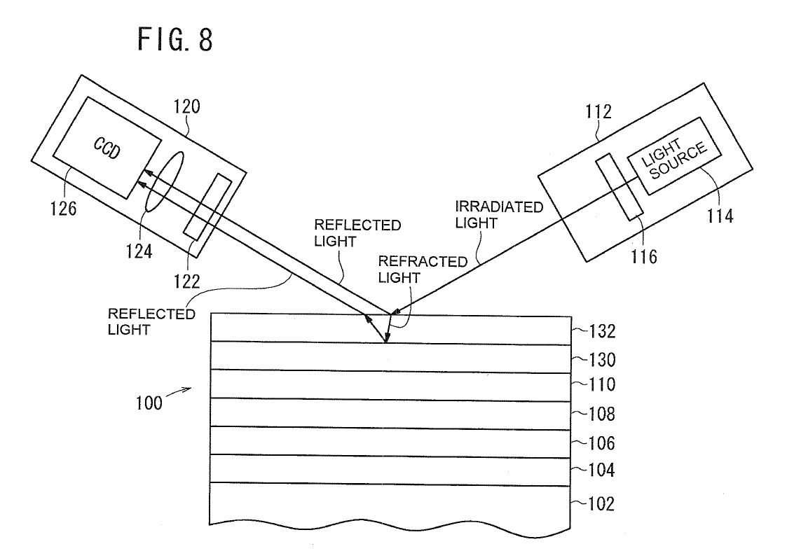

FIG. 6 is a view showing an example of an image which is picked up from a reflected light of the ultraviolet light irradiated by the irradiating portion 16 through the image pickup portion 20 illustrated in FIG. 5 and is subjected to a binarization by an image processing device 22 in the case in which a concavo-convex portion is generated on the surface of the workpiece 30, that is, the overcoated clear film 60.

As shown in FIG. 6, in the case in which the overcoated clear film 60 has the concavo-convex portion, the place in an irradiation range A becomes black. The concavo-convex portion is generated on a surface of the overcoated clear film 40 for the following reason. As described above, in a stage in which the undercoated film 34, the intercoated film 36, the overcoated base film 38 and the overcoated clear film 40 are formed on the basis 32, dust or refuse mixes. Consequently, the concavo-convex portion is generated in a place into which the dust or refuse mixes. The image processing device 22 analyzes a change in a concentration of the image subjected to the binarization, thereby inspecting a place having the refuse.

As described above, conventionally, a light in a waveband which is not absorbed by the overcoated clear film 40 is irradiated. In the case in which the overcoated base film 38 containing a luster pigment is formed under the surface coated film, therefore, a scattered light is generated by the overcoated base film 38 so that a projection chart taken onto the image picked up by the image pickup portion 20 is distorted or a halation is caused. In the case in which the decorating seal 58 having a character printed thereon is formed under the surface coated film, moreover, an image of the character of the decorating seal 58 is picked up. Although the overcoated clear film 40 originally has no concavo-convex portion, consequently, it is decided that the concavo-convex portion is present. As a result, the precision in the inspection is reduced. According to the embodiment, however, the surface coated film absorbs the light. Therefore, it is possible to suppress an occurrence of scattering or reflection of a refracted light which is incident on the surface coated film. Consequently, it is possible to enhance the precision in the inspection of the surface. In other words, it is possible to pick up an image of only the light reflected by the surface coated film. Therefore, it is possible to enhance the precision in the inspection of the surface.

Thus, there is irradiated the ultraviolet light which can be absorbed by the surface coated film forming the surface of the workpiece 30. Therefore, there is no influence of the overcoated base film 38. Consequently, it is possible to enhance the precision in the inspection of the surface.

In the embodiment, since the surface coated film of the workpiece 30 absorbs the ultraviolet light, the irradiating portion 16 irradiates the ultraviolet light. However, the waveband of the light to be absorbed and that of the light to be irradiated are not restricted to the ultraviolet light. It is preferable that the surface coated film of the workpiece 30 should be constituted to absorb a light having a specific waveband and the irradiating portion 16 should irradiate the specific waveband. In this case, it is preferable that the image pickup portion 20 should have a sensitivity to the waveband of the light to be irradiated by the irradiating portion 16 and the image pickup portion 20 should be prevented from picking up an image of a light other than the light in the waveband irradiated by the irradiating portion 16.

Although the arm 26 of the robot 28 holds the workpiece 30 and the surface to be the inspecting target in the workpiece 30 is moved relatively with the image pickup portion 20 so that the image pickup portion 20 can scan the surface to be the inspecting target, moreover, the image pickup portion 20 may be provided on a tip of the arm 26 of the robot 28 and the arm 26 may move the image pickup portion 20 relatively with the surface to be the inspecting target in such a manner that the image pickup portion 20 can scan the surface to be the inspecting target. In this case, the irradiating portion 16 may be provided on the tip of the arm 26 in addition to the image pickup portion 20 and the arm 26 may move the image pickup portion 20 and the irradiating portion 16 relatively with the surface of the workpiece 30 which serves as the inspecting target. In short, it is preferable to provide means capable of moving the image pickup portion relatively with the surface of the workpiece 30 in such a manner that the image pickup portion 20 can scan the surface of the workpiece 30.

In accordance with the above exemplary embodiment, the surface inspecting apparatus is provided with: an irradiating portion configured to irradiate a light in a specific waveband onto a surface coated film which is formed on a surface of a workpiece and absorbs a light in said specific waveband; an image pickup portion having a sensitivity to a light in said specific waveband and configured to pick up an image of a reflected light of the light irradiated onto the workpiece by the irradiating portion; an inspecting portion configured to inspect a condition of the surface coated film based on the image picked up by the image pickup portion; and a scanning portion configured to relatively move the surface of the workpiece with respect to the image pickup portion.

Moreover, in accordance with the above exemplary embodiment, the surface inspecting method includes the steps of: irradiating a light in a specific waveband onto a surface coated film which is formed on a surface of a workpiece and absorbs said specific waveband; picking up an image of a reflected light of the light irradiated onto the workpiece by an image pickup portion having a sensitivity to a light in said specific waveband; and inspecting a condition of the surface coated film based on the image picked up.

In the apparatus and method of the exemplary embodiment, the specific waveband may be a waveband of an ultraviolet ray.

In the apparatus and method of the exemplary embodiment, the specific waveband may be in a range of a UV-A waveband.

In the apparatus and method of the exemplary embodiment, the workpiece may have a decorating seal under the surface coated film.

In the apparatus and method of the exemplary embodiment, the workpiece may have an undercoated film containing a luster pigment under the surface coated film.

According to the apparatus and method of the exemplary embodiment, a light does not reach a layer provided under the surface coated film of the workpiece. Therefore, it is possible to pick up an image of only a light reflected by the surface coated film. Consequently, it is possible to enhance precision in the inspection of the surface.

Moreover, the waveband of the ultraviolet rays is the UV-A waveband. Therefore, it is possible to lessen an influence of the ultraviolet rays over a human body.

It will be apparent to those skilled in the art that various modifications and variations can be made to the described exemplary embodiment of the present invention without departing from the spirit or scope of the invention. Thus, it is intended that the present invention cover all modifications and variations of this invention consistent with the scope of the appended claims and their equivalents.

### DESCRIPTION OF REFERENCE NUMERALS AND SIGNS

10 surface inspecting apparatus
12 system control panel
14 irradiation driving portion
16, 112 irradiating portion
18 image pickup driving portion
20 image pickup portion
22 image processing device
24 robot controller
26 arm
28 robot
30, 100 workpiece
32, 102 basis
34, 104 undercoated film
36, 106 intercoated film
38, 108 overcoated base film
40, 110 overcoated clear film
58 decorating seal
68 overcoated clear film

What is claimed is:

1. A surface inspecting apparatus comprising:
an irradiating portion configured to irradiate a light in a specific waveband onto a surface coated film which is formed on a surface of a workpiece and absorbs a light in said specific waveband;
an image pickup portion having a sensitivity to a light in said specific waveband and configured to pick up an image of a reflected light of the light irradiated onto the workpiece by the irradiating portion;
an inspecting portion configured to inspect a condition of the surface coated film based on the image picked up by the image pickup portion; and
a scanning portion configured to relatively move the surface of the workpiece with respect to the image pickup portion.

2. The surface inspecting apparatus according to claim 1, wherein the specific waveband is a waveband of an ultraviolet ray.

3. The surface inspecting apparatus according to claim 2, wherein the specific waveband is in a range of a UV-A waveband.

4. The surface inspecting apparatus according to claim 1, wherein the workpiece has a decorating seal under the surface coated film.

5. The surface inspecting apparatus according to claim 1, wherein the workpiece has an undercoated film containing a luster pigment under the surface coated film.

6. A surface inspecting method comprising:
irradiating a light in a specific waveband onto a surface coated film which is formed on a surface of a workpiece and absorbs said specific waveband;
picking up an image of a reflected light of the light irradiated onto the workpiece by an image pickup portion having a sensitivity to a light in said specific waveband; and
inspecting a condition of the surface coated film based on the image picked up.

7. The surface inspecting method according to claim 6, wherein the specific waveband is a waveband of an ultraviolet ray.

8. The surface inspecting method according to claim 6, wherein the specific waveband is in a range of a UV-A waveband.

9. The surface inspecting method according to claim 6, wherein the workpiece has a decorating seal under the surface coated film.

10. The surface inspecting method according to claim 6, wherein the workpiece has an undercoated film containing a luster pigment under the surface coated film.
